(19) United States
(12) Patent Application Publication
(10) Pub. No.: US 2012/0211493 A1
(43) Pub. Date: Aug. 23, 2012

(54) NON-LINER CONTAINER

(75) Inventor: Barry Daggett, Austintown, OH (US)

(73) Assignee: WEATHERCHEM CORPORATION, Twinsburg, OH (US)

(21) Appl. No.: 13/403,720

(22) Filed: Feb. 23, 2012

Related U.S. Application Data
(60) Provisional application No. 61/445,618, filed on Feb. 23, 2011.

(51) Int. Cl. B65D 45/02; B65D 21/036; B29C 45/14; B65D 43/22

(52) U.S. Cl. 220/315; 206/508; 264/242

(57) ABSTRACT

Containers that are disposable and leak proof and methods of making and using the container are provided. The containers can be hermetically sealed without the utilization of linear sealing and capping. The container comprises a body portion and a lid portion operatively connected to the container portion with, for example, a living hinge. The container also comprises a gasket comprising built in compression and a positive lock, wherein the gasket and the positive lock operate in conjunction to produce an audible sound when the lid portion is engaged with the body portion. The gasket can be formed integral to the lid portion or the body portion, wherein the built in compression facilitates compression of the gasket to flip the positive lock into a secure position when the lid portion is engaged with the body portion.

### CROSS-REFERENCE TO RELATED APPLICATIONS

This application claims the benefit of U.S. Provisional Application Ser. No. 61/445,618, filed Feb. 23, 2011, and entitled “SPECIMEN CONTAINER”, the entirety of which is expressly incorporated herein by reference.

### TECHNICAL FIELD

The following description relates generally to a container and more particularly to a non-liner container.

### BACKGROUND

Containers are used to hold a variety of products ranging from solid materials (e.g., breath mints, cookies, and so on), to powder or granular materials (e.g., cosmetics, fabric detergent, and so forth), to liquid products (e.g., fabric softener, beverages, and so forth). Further, the product within the container can be a product that should be protected from excessive moisture and/or external contamination. In some examples, it might be beneficial to prevent leakage of the product from the container to prevent waste and/or to retain the integrity of the product.

In a specific example, biological specimen containers are widely used in medical facilities (e.g., hospitals, emergency care centers, physician's offices, private laboratories, and the like) to obtain biological samples or specimens from patients. The patient specimens are generally analyzed in a medical laboratory and, therefore, need to be transported from the collection site to the medical laboratory. In the case of a hospital, the medical laboratory might be located on-site. However, in the case of other medical facilities (e.g., physician's office, urgent care centers), the medical laboratory might be located in a different building or even across town (e.g., off-site).

Regardless of whether the medical laboratory is on-site or off-site, there are concerns related to contamination of the specimen and/or the risk of breakage or leakage of the specimen from the container. Thus, persons handling the specimens can be in danger of being inadvertently exposed to hazardous infective agents if the specimen is spilled or leaks from the container. Such infective agents include viruses (hepatitis, HIV, and so forth) and other agents that can cause infectious diseases. Further, if the specimen becomes contaminated, it might result in a misdiagnosis and/or the need for collection of a new specimen, which can induce needless delays (which can compromise the health of the patient).

Therefore, the safe handling of specimens is highly desirable in view of the large number and the potential severity of hazards associated with specimen collection and handling. Accordingly, there is a need for biological specimen containers that are not susceptible to breakage or leakage. Further, there is a need for specimen containers that can be sealed and/or unsealed in an efficient and reliable manner. Further, the costs to produce the specimen container should be kept to a minimum so that such disposable containers are not cost prohibitive and do not add significantly to the cost of health care.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect relates to a container comprising a body portion, a lid portion, and a hinge that operatively connects the lid portion to the body portion in a movable arrangement. The container also comprises a gasket formed with the body portion or the lid portion. The gasket comprises built in compression. The container also comprises a positive lock comprising a first element located on the lid portion and a second element located on the body portion. At least a section of the first element engages at least a section of the second element when the lid portion is brought into contact with the body portion. The built in compression and the engagement of the first element in the second element provides an audible indication of a moisture proof seal between the body portion and the lid portion.

Another aspect relates to a method comprising forming a body portion and a lid portion, wherein the body portion and the lid portion are operatively connected with a hinge. The method also comprises forming a gasket with the body portion or the lid portion, wherein the gasket comprises built in compression. Further, the method comprises forming a first element on the lid portion and a second element on the body portion, wherein the first element and the second element comprise a positive lock.

To the accomplishment of the foregoing and related ends, one or more aspects comprise features hereinafter fully described and particularly pointed out in the claims. The following description and annexed drawings set forth in detail certain illustrative features of one or more aspects. These features are indicative, however, of but a few of various ways in which principles of various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

Various non-limiting embodiments are further described with reference to the accompanying drawings in which:

FIG. 1 illustrates a container, according to an aspect;

FIG. 2 illustrates a cross section view of a portion of the container with a lid portion engaged with a container portion, according to an aspect;

FIG. 3 illustrates a cross-section view of the container with the lid portion in engagement with the container portion, according to an aspect;

FIG. 4 illustrates a cross-sectional view of a portion of the container representing the lid portion in engagement with the container portion, according to an aspect;

FIG. 5 illustrates the container, wherein the lid portion is selectively disengaged from the container portion, according to an aspect;

FIG. 6 illustrates a top view of the container, according to an aspect;

FIG. 7 illustrates another top view of the container with portions darkened to show a thumb tab push area, according to an aspect;

FIG. 8 illustrates a front view of another embodiment of a container, according to an aspect;

FIG. 9 illustrates a side perspective view of the container of FIG. 8, according to an aspect;

FIG. 10 illustrates another view of the container of FIG. 8, wherein a lid portion is in an open position, according to an aspect;

FIG. 11 illustrates a side view of the container of FIG. 10, according to an aspect;

FIG. 12 illustrates a method for manufacturing a container, according to an aspect;

FIG. 13 illustrates a method 1300 for forming a non-liner container, according to an aspect.

FIG. 14 illustrates a method for utilizing the container, according to an aspect; and

FIG. 15 illustrates another method for utilizing the container, according to an aspect.

### DETAILED DESCRIPTION

Various embodiments or features are described with reference to the drawings, wherein like reference numerals are used to refer to like elements throughout. In the following description, for purposes of explanation, numerous specific details are set forth in order to provide a thorough understanding of the subject disclosure. It may be evident, however, that the disclosed subject matter can be practiced without these specific details, or with other methods, components, materials, and so forth.

By way of introduction, the disclosed aspects provide a container, including a body portion and a lid portion, that is leak proof. For example, the container can comprise a positive lock and/or a gasket configured to provide the leak proof features. Further, the container can remain leak proof under pressurization (e.g., air shipment). In an aspect, the container can be resealed multiple times. Further, the container can be easily opened and closed, which can facilitate usage of the container by persons with hand problems (e.g., arthritis, hand deformations, missing fingers and/or thumbs, and so forth). The disclosed aspects can also provide positive feedback (e.g., in visible and/or audio form) so that a user is provided an indication that the container is closed and sealed.

According to some aspects, the container can hold various products, such as vitamins or liquids. In the case of vitamins or other first aid products (e.g., aspirin), a liner is generally placed over the mouth of the container and has to be peeled back in order to gain access to the container contents. If the liner has been damaged or removed, it can indicate that someone has tampered with the product. However, it can be easy for someone to carefully peel back the liner (but not completely remove the liner from the container) and, after adding or removing items from the container, can replace the liner and cap on the container. When a person purchases the product, it might not be easily ascertained whether the liner did not completely seal with the container during manufacturing (and there has been no tampering with the product) or whether the product was in fact tampered with, which can have drastic consequences.

To overcome such uncertainty with the user of a liner, in accordance with some aspects, provided is a container that is manufactured in a manner that eliminates use of the liner by providing a hermetically sealed container that does not utilize a liner (e.g., non-liner container). The container can comprise a body portion and a lid portion, wherein the body portion is filled with product and the lid portion is closed over the body portion. With the lid portion in engagement with the body portion, the container assembly (e.g., lid portion and body portion) can be shrink wrapped, wherein the shrink wrap over the container assembly is removed in order to gain access to the container contents. Such shrink wrap protection provides an immediate indication of whether the product has been tampered with as the shrink wrap cannot be easily replaced. The elimination of a liner can provide manufacturing efficiencies since placement of a liner, placing a cap over the liner and/or heating the liner is not utilized with the disclosed aspects.

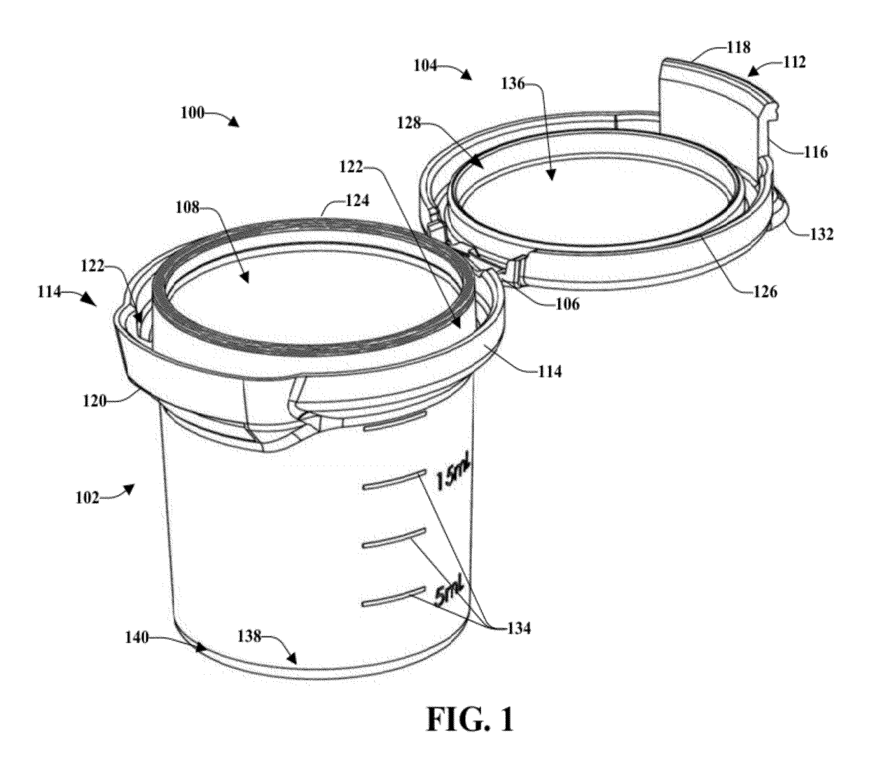

Turning to the figures, FIG. 1 illustrates a container 100, according to an aspect. In accordance with some aspects, the container 100 can be a disposable biological specimen container. However, according to some aspects, the container 100 can be another type of container. Advantages of the disclosed aspects include a low cost method of manufacturing a container. Another advantage is a container that comprises a leak proof seal between a lid portion and a body portion. A further advantage is a container that provides an audible means and/or a visual means of verifying closure of the container and operation of a leak proof seal between the lid portion and the body portion.

The container 100 comprises a body portion 102 and a lid portion 104 (e.g., flip top). The body portion 102 is configured to accept and retain product or contents, which can be in liquid form, powdered form, solid form, or any other form. The lid portion 104 is configured to securely engage over the body portion 102 in a manner that retains the contents within the body portion 102.

In accordance with some aspects, the body portion 102 and the lid portion 104 can be made of the same material or of a similar material. In some aspects, the body portion 102 and the lid portion 104 are formed of different materials. According to some aspects, the body portion 102 and/or the lid portion 104 are formed of an injection molded suitable thermoplastic material (e.g., polymer, polypropylene, and so forth) or other material known in the art.

In accordance with some aspects, the body portion 102 and/or the lid portion 104 is formed with clear or transparent material, which can allow for viewing of the container contents. For example, the body portion 102 and/or lid portion 104 can be formed of clear polypropylene. However, according to other aspects, the body portion 102 and/or lid portion 104 can be formed of a colored material or a non-transparent material or different colored materials. For example, the body portion 102 can be formed of a material having a first color and the lid portion 104 can be formed of a material having a second color. Further, the body portion 102 and/or lid portion 104 can be formed of any number of different combination of clear or transparent material ad/or colored or non-transparent material. For example, the container can be formed of both clear material and colored material (e.g., the lid portion 104 is formed of clear material and the body portion 102 is formed of colored material, or vice versa). According to an aspect, the container is formed of Food and Drug Administration (FDA) resin. Further, use of a medical “clean room” is not needed with the disclosed aspects. In accordance with some aspects, the containers disclosed herein can be supplied in bulk packaging.

The body portion 102 and the lid portion 104 can be a unitary or a one-piece structure. In accordance with some aspects, the body portion 102 and lid portion 104 comprise a two-piece structure. It should be noted that although the various aspects are illustrated as a generally circular body portion 102 and lid portion 104, the various aspects are not limited to this implementation. In accordance with some aspects, the body portion 102 and lid portion 104 can have a different geometric shape (e.g., oval, oblong, rectangular, irregular, and so on).

The lid portion 104 can be pivotally joined to the body portion 102 by, for example, a hinge 106. The hinge 106 can be configured to mitigate cracks that might develop at or along one or more flex portions of the hinge 106 and can be constructed of a relatively thin wall that is configured to flex without breakage during an expected service life of the container 100. For example, the hinge 106 can be formed of a material that has at least some flexibility and/or that can deform slightly or significantly in order to mitigate cracking and/or breakage of the hinge 106. In accordance with some aspects, the hinge 106 can be formed with the same or similar material as the body portion 102 and/or the lid portion 104. In other aspects, the hinge 106 can be formed of a material that is different than the material used to form the body portion 102 and/or the lid portion 104.

The hinge can be a “living hinge”, a “pivoting hinge”, or another type of hinge. A living hinge is a hinge formed with the body portion 102 and the lid portion 104 as a single piece. A living hinge can be configured to facilitate the lid portion 104 being able to spring away from the body portion 102 when the container 100 is to be opened. A pivoting hinge is formed at substantially the same time as the body portion (or the lid portion), wherein the body portion and the lid portion are formed as separate pieces and snapped together at the hinge to combine the two pieces into a single container assembly.

The hinge 106 lies in a plane perpendicular to the axis of an opening or mouth 108 of the body portion 102. The hinge 106 also provides ease of moving the lid portion 104. For example, the hinge 106 operatively connects the lid portion to the body portion 102 in a movable arrangement, wherein the lid portion 104 comprises at least two positions, namely, a first position and a second position. When in the first position, the lid portion 104 is “open” (or moved away from the body portion 102), which allows product (e.g., a specimen) to be placed into the container 100 (e.g., into the body portion 102) and/or dispensed from the container 100. When the lid portion 104 is in the second position, the lid portion 104 is closed or engaged with the body portion 102, providing a secure and leak proof seal according to various aspects disclosed herein. Thus, the hinge 106 allows the lid portion 104 to be moved away from the body portion 102 (e.g., flipped up, placed into first position) for dispensing and/or for filling. The hinge 106 can allow the lid portion 104 to be moved into contact with the body portion 102 (e.g., placed into the body position) for storage, transport purposes, and/or for other purposes.

Ordinarily, the lid portion 104 is installed upright on the top of the body portion 102 that has a mouth 108 that typically lies in a horizontal plane. For purposes of discussion, the vertical direction generally corresponds to an axial direction with reference to the geometry of the container (comprising the body portion and the lid portion) and the horizontal direction or horizontal plane is perpendicular to the axial direction of the container (e.g., the vertical direction). It should be understood that during fabrication, molding, shipping, storage, and so forth, the body portion and/or lid portion could have a non-upright orientation.

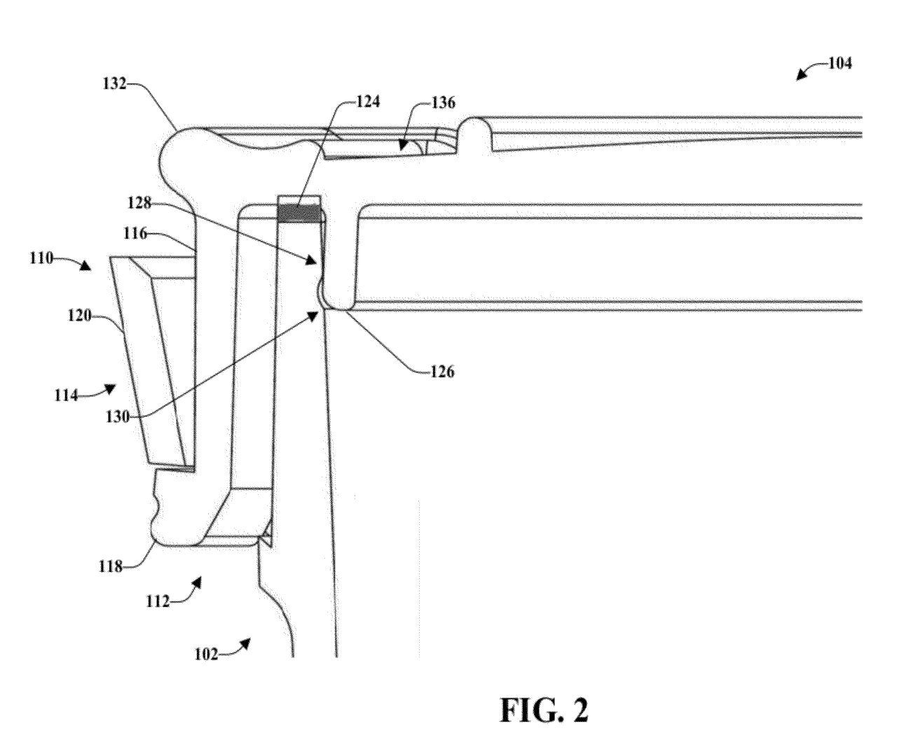

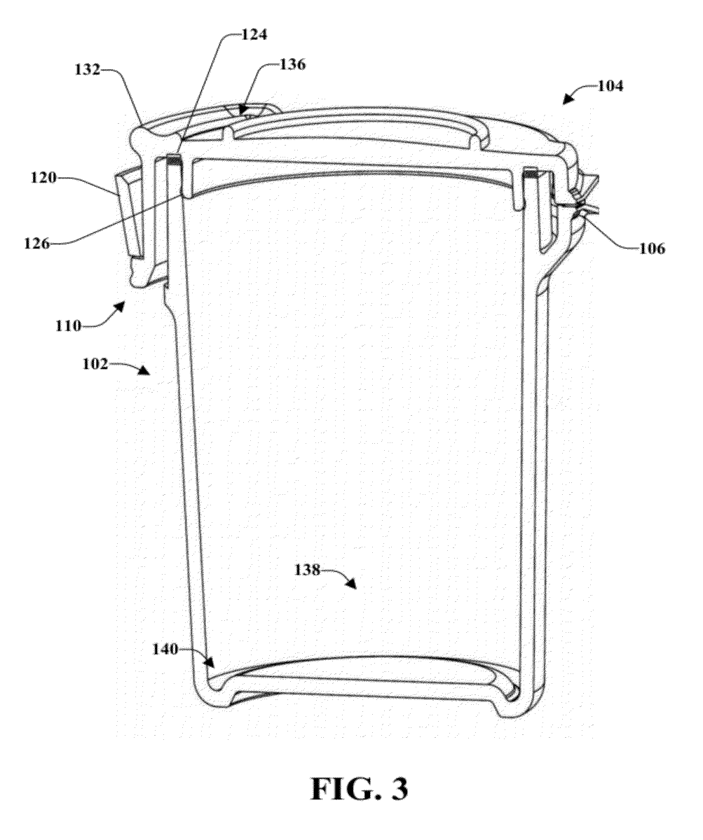

Further, the container 100 comprises a locking mechanism 110 (illustrated in FIGS. 2-4) configured to retain the lid portion 104 is secure engagement with the body portion 102. The locking mechanism 110 comprises a first element located on the lid portion 104 and a second element located on the body portion 102. At least a section of the first element engages at least a section of the second element when the lid portion 104 is brought into contact with the body portion 102. For example, the first element can be a lock member 112, located on the lid portion 104, and the second element can be a receiver member 114, located on the body portion 102. The lock member 112 is configured to engage with the receiver member 114. In accordance with some aspects, the locking mechanism 110 can comprise a secure positive lock (or a push button lock) that is configured to help prevent inadvertent opening of the container 100, which could result in spillage and/or contamination of the container contents.

The lock member 112 comprises a surface area 116 and a protrusion 118 that are utilized to “lock” and “unlock” the locking mechanism 110. A closing force that can be applied to close the lid portion can be about 10 pounds. In accordance with some aspects, the closing force can be less than about 10 pounds. The receiver member 114 comprises a substantially vertical piece 120 and a cavity 122 that are configured to provide a receiving area (e.g., cavity 122) for the lock member 112. In accordance with some aspects, the cavity 122 is an extension of the opening or mouth 108.

The lock member 112 is configured to engage inside the receiver member 114, as shown in FIGS. 2, 3, 4, 6, and 7. The lock member 112 can be inserted (at least partially) into the cavity 122 (e.g., receiving area) of the receiver member 114. After insertion, the lock member 112 can be operatively connected to (or engaged with) the receiver member 114 (as shown in FIG. 2). For example, the protrusion 118 can be formed at a lower edge of the lock member 112. The protrusion 118 is configured to engage with an underside of the receiver member 114 (e.g., vertical piece 120), which holds the lock member 112 in engagement with the receiver member 114 in a secure manner.

Flexibility of the lock member 112 allows the surface area 116 to move slightly inward (toward the mouth 108 of the container 100) as the lid portion 104 is closed over the body portion 102 and lock member 112 is inserted into the cavity 122 of the receiver member 114. The surface area 116 of the lock member 112 moves along (or inside) the cavity 122 between the receiver member 114 and the body portion 102.

When the lock member 112 clears the vertical piece 120 of the receiver member 114, the protrusion 118 moves in a direction away from the container 100 (e.g., body portion 102), and the protrusion 118 engages the underside of the receiver member 114 (or the vertical piece 120) in a locked manner. The locking mechanism 110 helps to ensure that the lid portion 104 is securely engaged with the body portion 102 (e.g., the lid portion 104 cannot just be pulled away from the body portion 102, as might occur were the container dropped and/or the secure lock not provided (or not utilized)).

When it is desired to open the lid portion 104, horizontal force is applied to the protrusion 118. The horizontal force causes the protrusion 118 and surface area 116 to move inward, in a direction toward the body portion 102. This causes the lock member 112 to disengage from the receiver member 114 (e.g., vertical piece 120). At about the same time as the protrusion 118 is cleared from (e.g., moved away from) the receiver member 114, slight upward pressure causes the lid portion 104 to move away from the body portion 102 (e.g., the movement can be facilitated by the hinge 106). Thus, horizontal force is applied to push in on the lock member 112 and the hinge 106 (and a gasket compression) causes the lid portion 104 to spring away from the body portion 102.

In accordance with some aspects, the receiver member 114 can be shrouded in order to provide protection so that the lock member 112 is not disengaged from the body portion 102 prematurely (or when not desired). For example, pressing on the receiver member 114 (or the vertical piece 120) does not cause the lid portion 104 to open. Instead, pressure is required on the protrusion 118 in order to open the container 100 (e.g., disengage the lid portion 104 from the body portion 102).

The body portion 102 can comprises a seal or gasket 124. However, according to some aspects, the gasket can be formed in the lid portion 104. Forming the gasket in the lid portion 104 (rather than the body portion 102) can be more efficient or simpler with respect to manufacturing processes. Thus, the gasket 124 can be molded with the body portion 102 or with the lid portion 104. In accordance with some aspects, the gasket 124 is formed during a first injection molding process or during a second (or subsequent) shot in an injection molding (production mold) process. For example, the body portion 102 and lid portion 104 can be formed during a first molding process and the gasket 124 can be formed during a second molding process. In another example, the gasket 124 can be formed during a first molding process and the body portion 102 and lid portion 104 can be formed during a second molding process.

In accordance with some aspects, the gasket 124 can be colored to provide a positive visual indication that the container is closed and sealed. For example, the body portion 102 and the lid portion 104 can be formed of a clear material and the gasket 124 can be formed of a colored material (e.g., red, green, or another color). Providing a colored or visible gasket 124 can provide the user with a visual indication of signs of compression, which can indicate a tight seal between the body portion 102 and the lid portion 104. However, in accordance with some aspects, the gasket 124 is clear or is substantially the same color as the body portion 102 and/or the lid portion 104. Further to this aspect, the gasket 124 is formed during an injection molding process and of a material similar to the material of the body portion 102. For example, during a two-shot injection molding process the gasket 124 and the body portion 102 can be bonded together.

The gasket 124 (or seal) is illustrated with a designed in compression. This designed in or built in compression can provide for tighter gasket sealing as compared with a container that does not have a gasket with built in compression. Additionally, the built in compression can be configured to produce an audible sound (e.g., an audible click) when the lid portion 104 is closed, which provides an indication that the lid portion 104 is fully engaged with the body portion 102. In accordance with some aspects, the built in compression and the engagement of the first element in the second element (of the lock member 112) can provide an audible indication (e.g., a click or other noise) of a seal between the body portion and the lid portion.

In accordance with some aspects, the lid portion 104 comprises a seal 126. In an aspect, the seal 126 can be a ring seal. The seal 126 (of lid portion 104) can be engaged between the lid portion 104 and the body portion 102. The seal 126 can provide protection against leakage of the container contents. In accordance with some aspects, the ring seal comprises a clean-out 128 and a dimple 130 that are configured to mate when the lid portion 104 is in engagement with the boy portion 102. In an aspect, the clean-out 128 and the dimple 130 form the ring seal when in a mated position. In some aspects, the seal 126 is a secondary ring seal that operates in conjunction with the gasket 124 to provide a tight, leak proof seal. However as previously discussed, in accordance with some aspects, the gasket 124 is integrated with the lid portion 104 and the seal is not utilized.

For example, the gasket 124 can be formed integral to the lid portion 104 and the built in compression can facilitate compression of the gasket 124 to flip the positive lock into a secure position when the lid portion 104 is engaged with the body portion 102. According to some aspects, the gasket 124 is formed integral to the body portion 102 and the lid portion 104 comprises a seal 126 that operates with the gasket 124 to facilitate a leak proof seal between the body portion 102 and the lid portion 104.

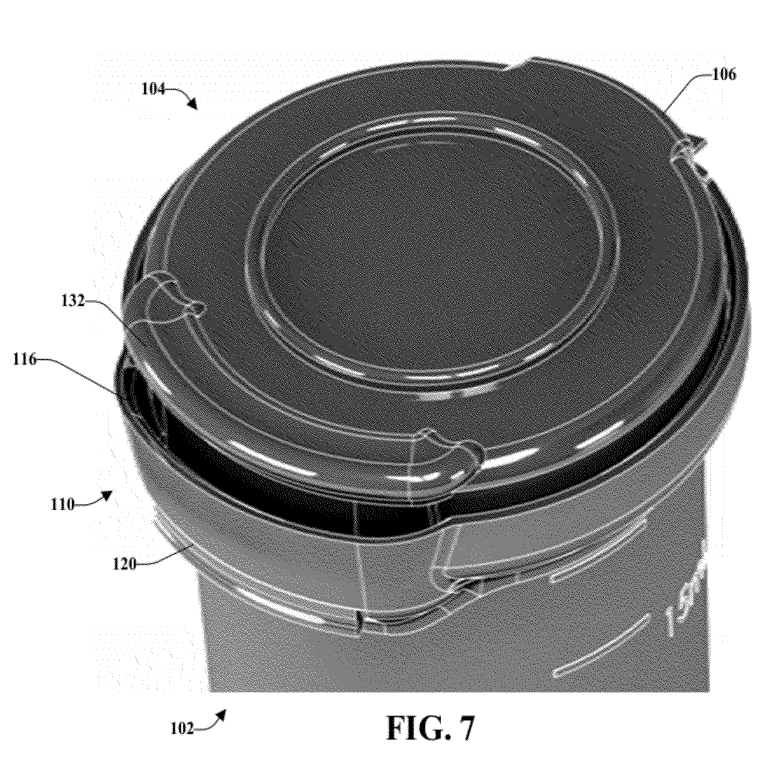

In accordance with some aspects, the lid portion 104 comprises a thumb tab push area 132 (illustrated in FIG. 7). The thumb tab push area 132 can allow for a higher closing force, which can aid in the sealing of the container 100, which can mitigate (or eliminate) leakage of contents from the container 100. For example, when the container is being closed, a person can press down on the thumb tab push area 132, which can cause greater deformity of the gasket 124 and/or seal 126.

The body portion 102 can also comprise one or more identification markers 134 that can be utilized to indicate an amount or level of the product (e.g., liquid, bodily fluid, and so on) placed within the container. For example, the identification markers 134 can be expressed in terms of milliliters (ML), however, other measures of volume or height within the container 100 can be utilized depending on the intended use of the container 100.

At least a portion of the lid portion 104 and at least a portion of the body portion 102 can comprise complementary stackable features. For example, lid portion 104 comprises a first complementary stackable feature and the body portion comprises 102 a second complementary stackable feature. The first complementary stackable feature of the container 100 is configured to selectively engage a second complementary stackable feature of a second container assembly. Further, the second complementary stackable feature of the container 100 is configured to selectively engage a first complementary stackable feature of a third container assembly. In such a manner, the container 100 can be stacked on top of the third container assembly and the second container assembly can be stacked on top of the container 100.

Lid portion 104 can also comprise a stacking ring 136 that is configured to allow stacking of container assemblies on top of each other. The stacking ring 136 can comprise a hollow area that can extend at least partially around the lid portion 104, in a contiguous or non-contiguous manner. For example, the hollow area can extend completely around the lid portion 104. However, the disclosed aspects are not so limited and the hollow area can extend at least partially around the lid portion 104 (e.g., some portion less than completely around the lid portion 104). Further, in some aspects, two or more hollow areas are provided, wherein the two or more hollow areas are non-contiguous (e.g., a hollow area followed by a non-hollow area followed by a hollow area, and so forth).

To facilitate the stacking of container assemblies, a base 138 of the body portion 102 comprises an extend portion 140 that is configured to engage inside a stacking ring or another container assembly. For example, a configuration of the stacking ring 136 and the extend portion 140 can be complementary such that the extend portion 140 engages in the stacking ring 136. In accordance with some aspects, the stacking ring 136 can be located on the base 138 and the extend portion 140 can be located on the lid portion 104.

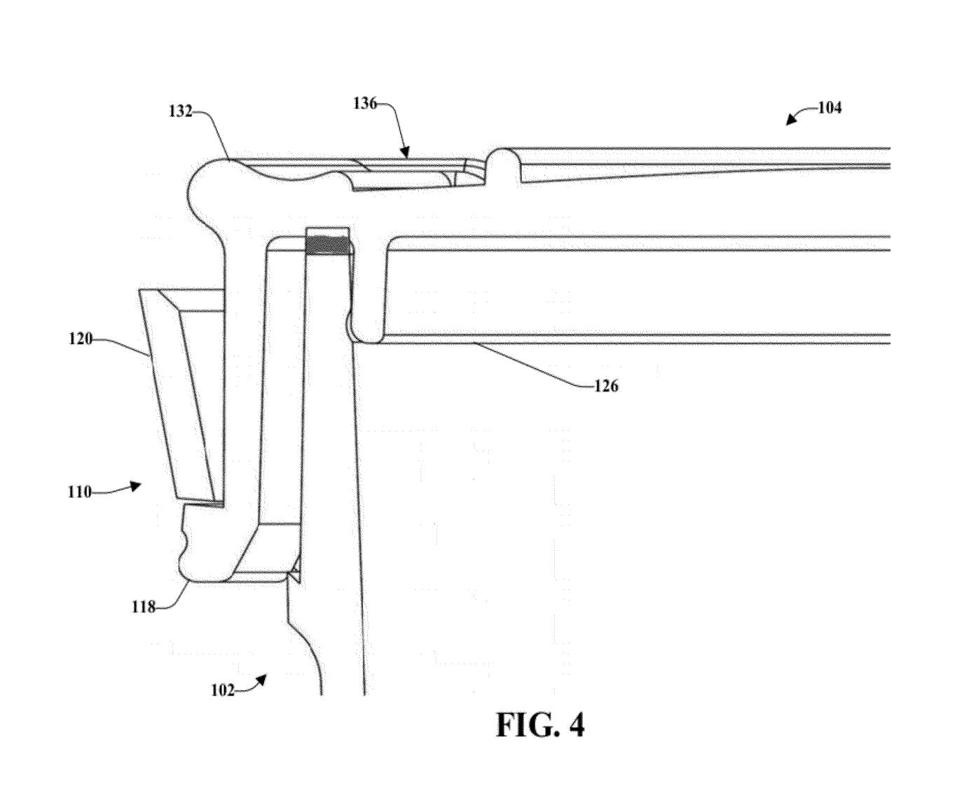

FIG. 4 illustrates a cross-sectional view of a portion of the container 100 representing the lid portion 104 in engagement with the body portion 102, according to an aspect. A horizontal force can be applied to the lid portion 104 (or the protrusion 118) in order to disengage the lid portion 104 from the body portion 102. The horizontal force is utilized to depress (or push inward relative to the container 100) the positive lock in order for the lock member 112 to disengage from the receiver member 114. For example, the horizontal force can be around 5 pounds. In accordance with some aspects, the horizontal force that should be applied is less than about 5 pounds. In other aspects, the horizontal force that should be applied is more than around 5 pounds. The horizontal force can be applied manually (e.g., by a human) or automatically (e.g., through the use of machinery).

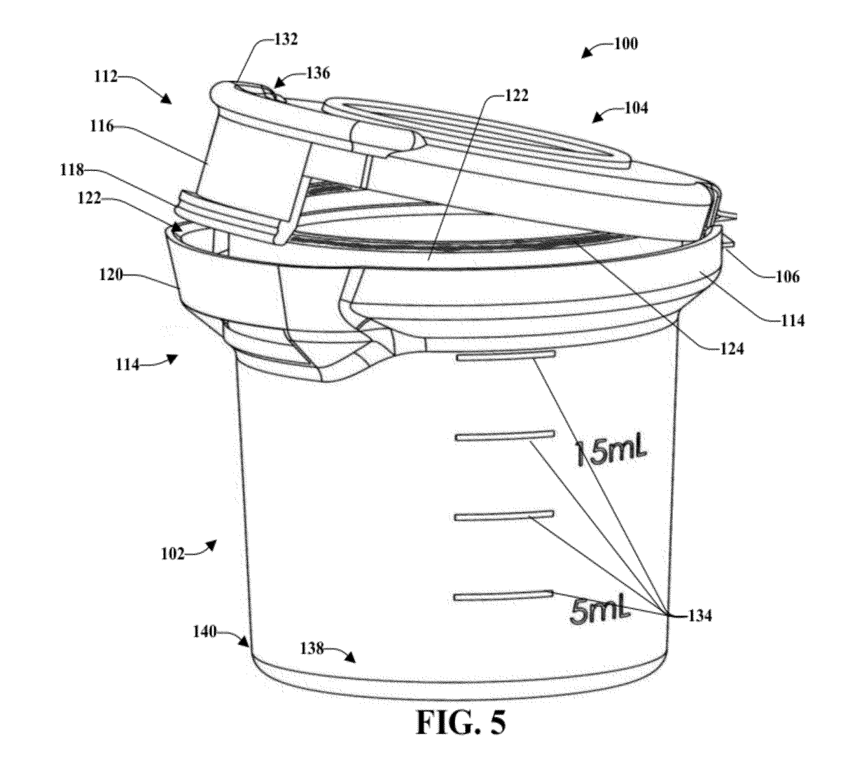

FIG. 5 illustrates the container 100, wherein the lid portion 104 is selectively disengaged from the body portion 102, according to an aspect. In accordance with some aspects, the hinge 106 is a living hinge and the lid portion 104 is configured to naturally “spring” open as a function of the operation of the living hinge and the gasket 124. The living hinge facilitates springing of the lid portion 104 away from the body portion 102. The gasket 124 provides built in compression that further facilitates movement of the lid portion 104 away from the body portion 102.

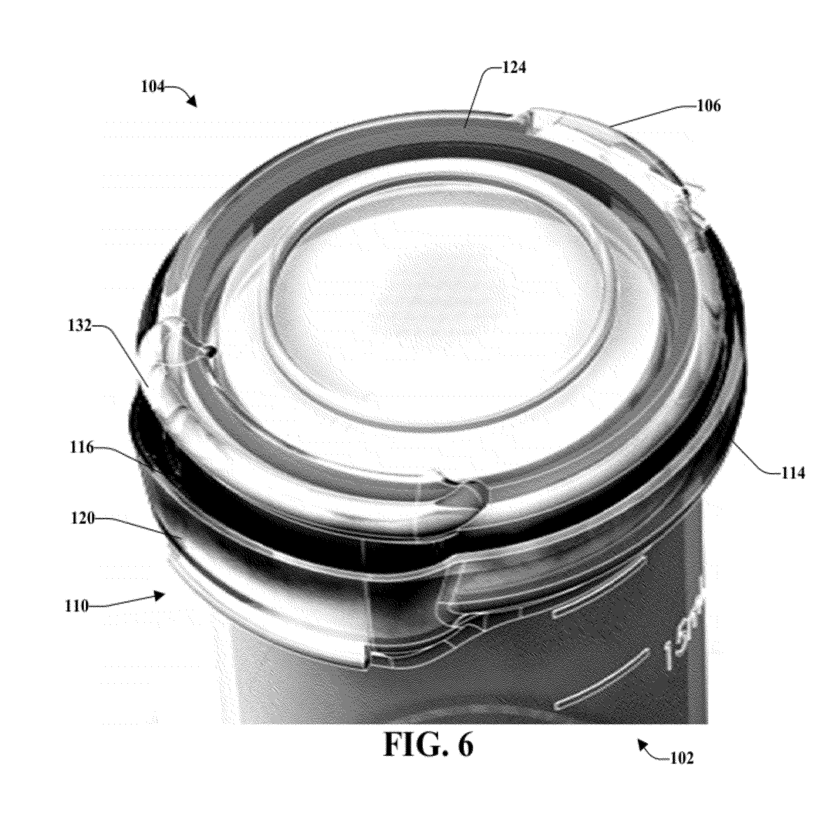

With reference now to FIG. 6, illustrated is a top view of the container 100, according to an aspect. When the lid portion 104 is being closed, an audible sound, such as a “click” can be heard from the locking mechanism 110. In accordance with some aspects, the gasket 124 can be seen through the lid and can provide visible signs of “compression”, which can allow the user to verify a leak proof closure.

FIG. 7 illustrates another top view of the container with portions darkened to illustrate the thumb tab push area 132, according to an aspect. The thumb tab push area 132 can be formed with a softer material as compared to a material of the body and the lid. For example, a body and lid can be formed with a first material and a gasket and the thumb tab push area can be formed with a second material. In accordance with some aspects, the thumb tab push area 132 is formed with the same or a similar material as the body portion 102.

In accordance with some aspects, the combination of a gasket and a positive lock is utilized to provide the ability to compress the gasket so that the lock flips into position, producing an audible sound such as a “click”. Compression of the gasket also mitigates slop or too much of a gap between the gasket and the container.

The thumb tab push area 132 can comprise a “soft” blended feature that can provide the user with a soft feel when the lid portion 104 is being closed (or engaged with the body portion 102). The thumb tab push area 132 can allow for a higher closing force, which can aid in the sealing of the container 100 (e.g., providing a secure contact between the lid portion 104 and the body portion 102), which can mitigate (or eliminate) leakage of contents from the container 100.

In accordance with some aspects, at least one container can undergo a non-pressurized seal testing. The testing can include ship testing, inverted seal testing, and side orientation testing. Further, the lid can be open and closed multiple times during one or more testing procedures to simulate actual use and to verify that no leaks form due to breakage at the hinge. In accordance with some aspects, pressurized seal testing can be conducted, wherein at least one container is placed in a pressurized chamber to determine altitude resilience.

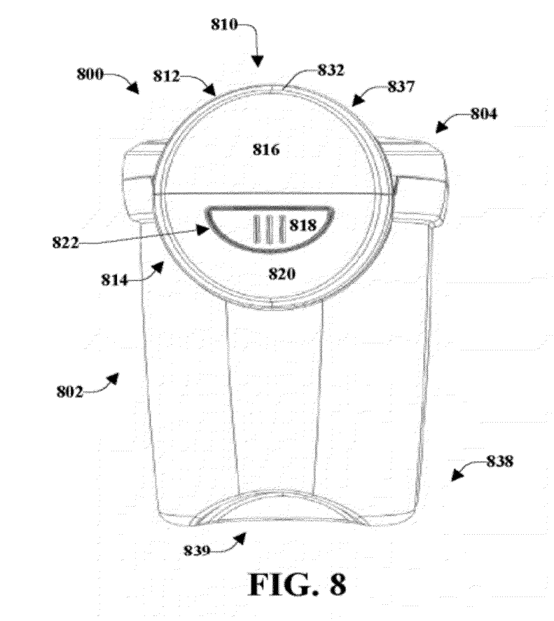

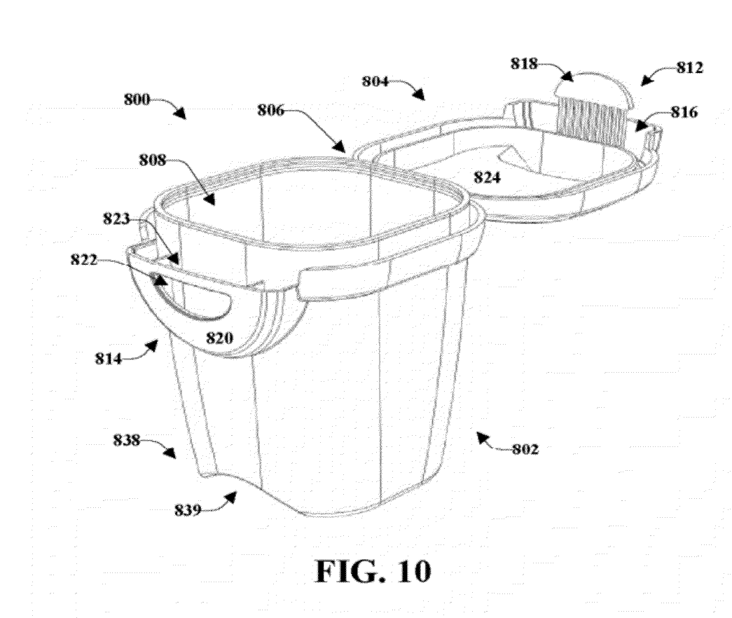

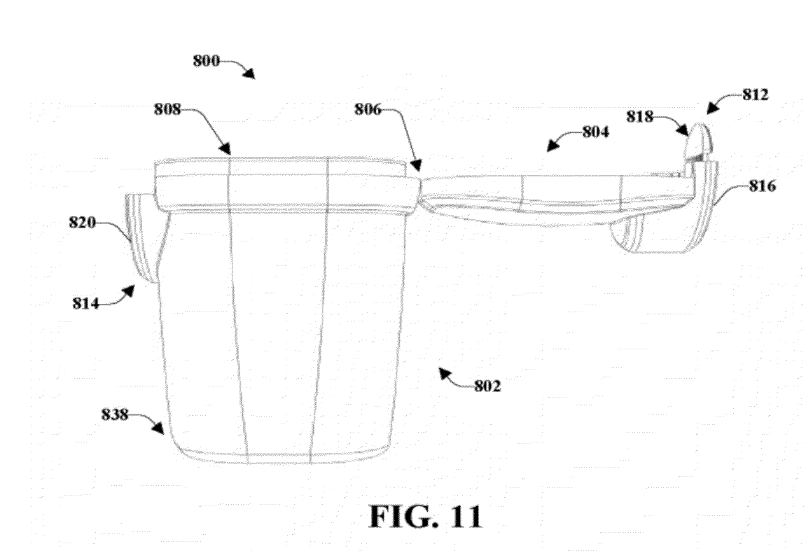

With reference now to FIGS. 8-11, illustrated is another embodiment of a container assembly 800, according to an aspect. The container assembly 800 is similar to the container 100 discussed with reference to FIGS. 1-7 and comprises a body portion 802 and a lid portion 804. The container assembly can be various sizes, for example, container assembly can be carried in a hand and the lid portion 804 opened (as illustrated in FIGS. 10 and 11) with the thumb. In accordance with some aspects, the container assembly can be large (e.g., 13 gallons, 55 gallons, and so forth) and configured to use as a refuse can, for example, wherein the disclosed aspects help mitigate an animal from gaining access to the container contents. However, the container assemblies disclosed herein can be various shapes and sizes.

In accordance with some aspects, the body portion 802 and lid portion 804 are formed as a unitary or one-piece structure. However, according to some aspects, the body portion 802 and lid portion 804 can comprise a two-piece structure (e.g., the body portion 802 and lid portion 804 are formed separately and operatively connected to form the container assembly 800).

The body portion 802 and the lid portion 804 can be formed of the same or a similar material. According to some aspects, the body portion 802 and lid portion 804 are formed of different materials. For example, the body portion 802 and/or lid portion 804 can be formed of an injection molded suitable thermoplastic material (e.g., polymer, polypropylene, and so forth) or other material known in the art. Further, the body portion 802 and the lid portion 804 can be formed with clear or transparent material and/or with a colored or non-transparent material, as discussed with reference to FIGS. 1-7.

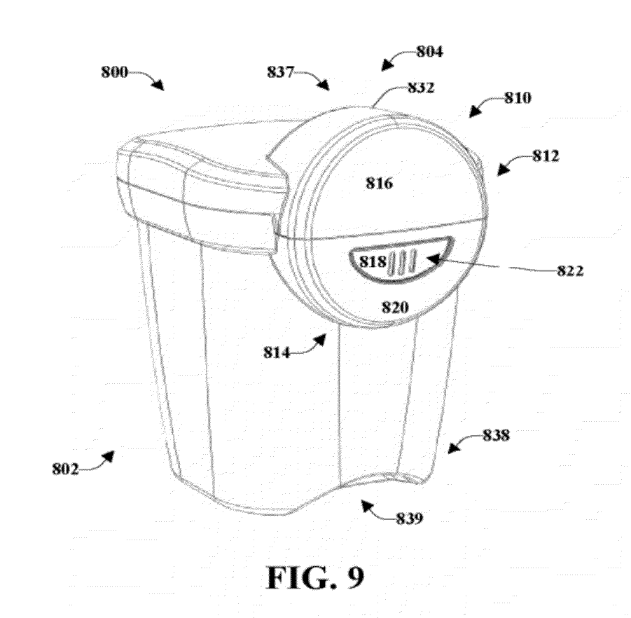

The body portion 802 and lid portion 804 are operatively connected by a hinge 806 that is configured to allow ease of movement of the lid portion 804 between a first position (e.g., away from the body portion 802 as illustrated in FIGS. 10 and 11) to allow container contents to be accessed through a mouth 808 of the body portion 802 and a second position (e.g., closed against the body portion 802 as illustrated in FIGS. 8 and 9). As discussed previously, the hinge 806 can be a living hinge, a pivoting hinge, or another type of hinge. Further, as discussed with reference to FIGS. 1-7, the hinge 806 can be constructed of a relatively thin wall configured to flex without breakage during an expected service life of the container assembly 800 and can be formed of the same or a different material than the body portion 802 and/or lid portion 804.

The container assembly 800 can comprise a locking mechanism 810 configured to retain the lid portion 804 in secure engagement with the body portion 802. For example, the locking mechanism 810 can comprise a lock member 812 (illustrated as integrated with the lid portion 804) configured to engage a receiver member 814 (illustrated as integrated with the body portion 802). In accordance with some aspects, the locking mechanism 810 can comprise a secure positive lock (or push button lock) configured to help prevent unintentional opening of the container assembly 800.

The lock member 812 can comprise a surface area 816 and a protrusion 818 that is utilized to ‘lock” and “unlock” the locking mechanism 810. The receiver member 814 can comprise a substantially vertical piece 820 and a cavity 822 configured to provide a receiving area for the lock member 812. As illustrated in FIGS. 8 and 9, the protrusion 818 is configured to engage the cavity 822. For example, the protrusion 818 can be inserted (at least partially) into the cavity 822, wherein the protrusion 818 is securely engaged with the cavity 822.

To close the lid portion 804, the lid portion 804 can be brought into close proximity with the body portion 802 and the surface area 816 can be depressed or pressed slightly inward with respect to the container assembly 800. The surface area 816 can be pushed inward (at various amounts of pressure) in order for the protrusion 818 to move between the vertical piece 820 and the body portion 802 such that the protrusion 8181 (at a least a portion of the surface area 816) clears the inside of the vertical piece 820. The inward movement of the surface area 816 can be facilitated by flexing of the surface area 816 at one or more locations. For example, the protrusion 818 and at least a portion of the surface area 816 can enter a space 823 (illustrated in FIG. 10) between the vertical piece 820 and the body portion 802. When pressure is released from the surface area 816, the protrusion 818 can move forward (e.g., away from the body portion 802) and engage the cavity 822. For example, the movement of the protrusion 818 away from the body portion 802 can be facilitated by the surface area 816 moving to a non-flexed position (or original position).

To open the lid portion 804, horizontal force can be applied to the protrusion 818 (or to the surface area 816) in a direction toward the body portion 802. The horizontal force can cause the protrusion 818 (due to associated flexing of the surface area 816) to move inward, away from the cavity 822 (and away from the vertical piece 820. This movement can cause the protrusion 818 to disengage from the cavity 822. A substantially upward (relative to the container assembly 800) movement can cause the surface area 816 and protrusion 818 to exit the space 823. The movement can be further facilitated by the hinge 806.

As illustrated in FIG. 10, a gasket 824 can be associated with an underside of the lid portion 804. In accordance with some aspects, the gasket 824 is a thermoplastic elastomer (TPE) gasket seal, however, other materials can be utilized with the disclosed aspects. According to some aspects, the gasket 824 can provide a moisture barrier that can mitigate moisture from entering (or leaving) the container assembly 800.

As illustrated, the lid portion 804 can comprises a thumb tab push area 832 which can be utilized to close the lid portion 804 over the body portion 802. For example, if enough downward force is applied to the thumb tab push area 832, downward movement of the protrusion 818 against the vertical piece 820 can cause the surface area 816 to flex such that the protrusion 818 and at least a portion of the surface area 816 enters the space 823. Further downward force can cause the protrusion 818 to engage the cavity 822.

Additionally or alternatively, in accordance with some aspects, the area labeled as the thumb tab push area 832 can operate as a stacking mechanism 837. For example, a base 838 of the body portion 802 can comprise a recessed area 839. A configuration of the stacking mechanism 837 and the recessed area 839 can be complementary such that when a first container is placed (or stacked) on top of a second container, a recessed area of the first container engages the stacking mechanism of the second container.

Further, as discussed previously the various aspects disclosed herein can eliminate liner sealing and capping. For example, a single piece of shrink wrap can be utilized to seal the container assembly 800. The shirk wrap can provide tamper evidence features, as previously discussed.

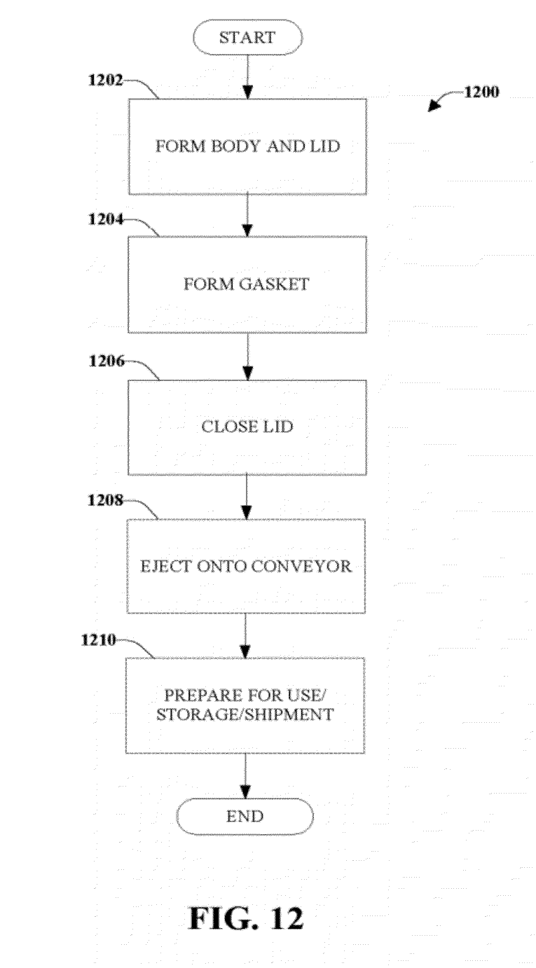

Turning now to FIG. 12, illustrated is a method for manufacturing a container, according to an aspect. At 1202, a body portion and a lid portion are formed. In accordance with some aspects, the body portion and lid portion are formed as a unitary unit. However, according to some aspects, the body portion and the lid portion are formed as two separate units. The forming of the body portion and the lid portion can be in an injection molding process. For example, the container (or portions thereof) can be formed by a multi-shot injection molding process (e.g., two-shot, three-shot, and so forth). Generally, each “shot” is an injection molding process.

In accordance with some aspects, the body portion and the lid portion are formed of the same material or a similar material. According to some aspects, the lid portion and the body portion are formed of different materials. In accordance with some aspects, the body portion and the lid portion can be formed of clear polymer resin.

According to various aspects, the body portion and the lid portion are formed as a single unit with a hinge there between. For example, the body portion and the lid portion are operatively connected with a living hinge. The body portion can comprise a first lock element and the lid portion can comprise a second lock element. The body portion, lid portion, and hinge can be formed as a single mold during a first shot injection molding process.

In some aspects, a second shot injection molding process can form a gasket, at 1204. However, in accordance with some aspects, the gasket can be formed, at 1204, during a first shot injection molding process and the body portion, lid portion, and hinge can be formed during a second shot injection molding process. The gasket can be formed of the same or a different colored material as the lid portion and body portion, according to an aspect. The gasket can be formed with built in compression. In accordance with some aspects, the gasket is formed on the lid portion. However, according to other aspects, the gasket if formed on the body portion.

The lid is closed, at 1206. For example, the lid can be closed while the container is in the mold (of the plastic injection machinery) and the lid can be closed pneumatically by the injection molding equipment. The container, with the lid closed, is ejected from the mold onto a conveyor, at 1208. In accordance with some aspects, the lid is closed and/or the container is removed from the mold manually. In accordance with some aspects, one or more steps are performed manually, automatically, or combinations thereof.

At 1210, the container is prepared for use, for storage, and/or for shipment. For example, the closed container can be moved on a conveyor belt and can travel through a “counter” that is configured to count each container as it passes. Thereafter, the container can be placed in a package (e.g., a lined box). After enough containers and/or boxes are loaded onto a pallet, the product is shipped, placed in storage, or placed in an area for use.

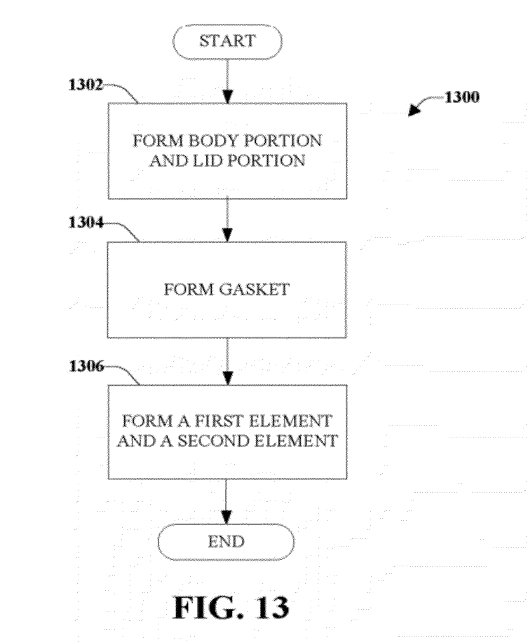

FIG. 13 illustrates a method 1300 for forming a non-liner container, according to an aspect. Method 1300 starts, at 1302, when a body portion and a lid portion are formed. The body portion and the lid portion can be operatively connected with a hinge. In an aspect, forming the body portion and the lid portion can comprise forming a living hinge between the body portion and the lid portion.

In accordance with some aspects, forming the lid portion and the body portion comprises forming a first complementary stackable feature on the lid portion and forming a second complementary stackable feature on the body portion. According to some aspects, forming the body portion and the lid portion comprises forming the body portion and the lid portion with a translucent material and forming the gasket comprises forming the gasket of colored material.

A gasket is formed with the body portion or the lid portion, at 1304. The gasket can comprise built in compression. According to an aspect, forming the gasket can comprise forming the gasket integral to the lid portion and the built in compression facilitates compression of the gasket to flip the positive lock into a secure position when the lid portion is engaged with the body portion. According to other aspects, forming the gasket comprises forming the gasket integral to the body portion and the lid portion comprises a seal that operates with the gasket to facilitate a leak proof seal between the body portion and the lid portion.

At 1306, a first element is formed on the lid portion and a second element is formed on the body portion. The first element and the second element comprise a positive lock. In accordance with some aspects, forming the first element and the second element comprises forming a lock member and a receiver member. The lock member can be configured to engage with the receiver member when the lid portion is closed over the body portion.

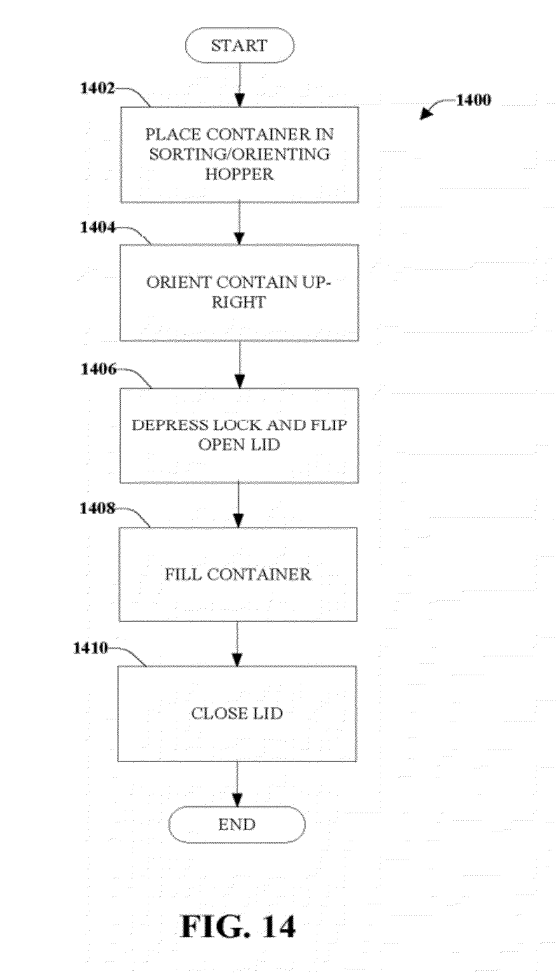

FIG. 14 illustrates a method 1400 for utilizing the container, according to an aspect. At 1402, the container can be placed in a sorting hopper and/or an orienting hopper. For example, during an intermediary use of the container, a medical facility or processing plant receives a pallet of closed containers. For example, the pallet can be shipped to the medical facility or processing plant. In another example, the containers can be produced by a manufacturing plant and removed from storage and/or a staging area.

At 1404, the container is oriented in an up-right position. For example, the container can be oriented in a lid opening station, wherein the lid is opened manually and/or automatically. For example, the containers can be removed from the box and put into a sorting hopper for automatic sorting and/or orientation. However, in accordance with some aspects, the closed containers are placed on a conveyer or put into position manually. For example, a person can manually place each container in an up-right orientation.

A positive lock that holds the lid in engagement with the body is depressed, at 1406, and the lid is flipped open to full open. The container is filled, at 1408. For example, the container can be filled with formalin. At 1410, the lid is closed. For example, the container can proceed to a lid “closing” station where the lid is closed automatically and/or manually. The closed container can be placed into storage and/or shipped.

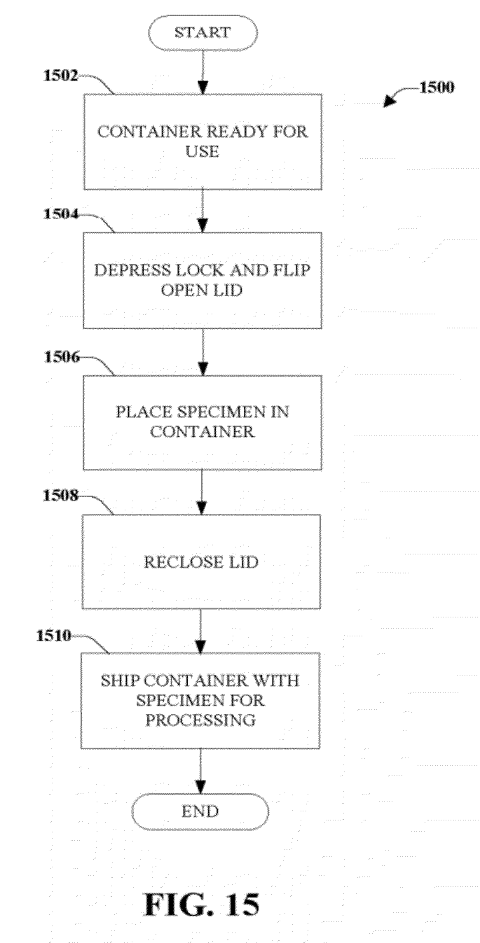

FIG. 15 illustrates another method 1500 for utilizing the container, according to an aspect. The container is ready for use, at 1502. For example, the container can be filled with an agent, as discussed with reference to FIG. 14. The containers can be ready for use at a medical facility, for example. At 1504, the lock is depressed and the lid is flipped open (e.g., by medical personnel). A specimen is placed in the container, at 1506, and the container is reclosed, at 1508. The container can be equipped with a positive lock that provides an audible sound (e.g., click) to indicate that the container is closed and sealed. At 1510, the sealed container that includes the specimen is sent for processing. For example, the sealed container can be placed in a biohazard bag with appropriate paperwork and the bag can be shipped to a laboratory for testing of the specimen.

As discussed above, the disclosed aspects provide containers that are not susceptible to breakage or leakage. Further, the disclosed aspects provide containers that can be sealed and/or unsealed in an efficient and reliable manner. Further, the disclosed aspects provide containers that are produced at a low-cost.

Provided herein is a non-liner container and a method of manufacturing the same. An aspect relates to a container comprising a body portion, a lid portion, and a hinge that operatively connects the lid portion to the body portion in a movable arrangement. In an example, the hinge is a living hinge.

The container also comprises a gasket formed with the body portion or the lid portion. The gasket comprises built in compression. The container also comprises a positive lock comprising a first element located on the lid portion and a second element located on the body portion. At least a section of the first element engages at least a section of the second element when the lid portion is brought into contact with the body portion. The built in compression and the engagement of the first element in the second element provides an audible indication of a moisture proof seal between the body portion and the lid portion.

In an example, the gasket is formed integral to the lid portion and the built in compression facilitates compression of the gasket to flip the positive lock into a secure position when the lid portion is engaged with the body portion. In another example, the gasket is formed integral to the body portion and the lid portion comprises a seal that operates with the gasket to facilitate a leak proof seal between the body portion and the lid portion.

According to an aspect, the first element is a lock member and the second element is a receiver member. The lock member is configured to engage with the receiver member when the lid portion is closed over the body portion. Further to this aspect, horizontal force and upward force applied to the lock member relative to the body portion causes the lock member to disengage from the receiver member.

According to an aspect, the lid portion comprises a first complementary stackable feature and the body portion comprises a second complementary stackable feature. In another aspect, the container further comprises a thumb tab push area configured to provide a closing force that aids in sealing the container.

In some aspects, the body portion is formed during a first molding process and the lid portion and the gasket are formed during a second molding process. In another aspect, the gasket is formed during a first molding process and the body portion and the lid portion are formed during a second molding process. In a further aspect, the body portion and the lid portion are formed of translucent material and the gasket is formed of colored material.

While the foregoing disclosure discusses illustrative aspects and/or embodiments, it should be noted that various changes and modifications could be made herein without departing from the scope of described aspects and/or embodiments as defined by the appended claims. Accordingly, described aspects are intended to embrace all such alterations, modifications, and variations that fall within the scope of the appended claims. Furthermore, although elements of described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is to be appreciated that functionality associated with at least some of the methods may be implemented by software, hardware, a combination thereof or any other suitable means (e.g. device, system, process, component, controller, injection molding machinery, and so on). Additionally, it should be further appreciated that methods disclosed throughout this specification are capable of being stored on an article of manufacture to facilitate transporting and transferring such methods to various devices. Those skilled in the art will understand and appreciate that a method could alternatively be represented as a series of interrelated states or events, such as in a state diagram.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additionally, in the subject description, the word “exemplary” (and variants thereof) is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete manner.

What is claimed is:

1. A container, comprising:
a body portion;
a lid portion;
a hinge that operatively connects the lid portion to the body portion in a movable arrangement;
a gasket formed with the body portion or the lid portion, wherein the gasket comprises built in compression; and
a positive lock comprising:
a first element located on the lid portion; and
a second element located on the body portion, wherein at least a section of the first element engages at least a section of the second element when the lid portion is brought into contact with the body portion, and
wherein the built in compression and the engagement of the first element in the second element provides an audible indication of a moisture proof seal between the body portion and the lid portion.

2. The container of claim 1, wherein the gasket is formed integral to the lid portion and wherein the built in compression facilitates compression of the gasket to flip the positive lock into a secure position when the lid portion is engaged with the body portion.

3. The container of claim 1, wherein the gasket is formed integral to the body portion and wherein the lid portion comprises a seal that operates with the gasket to facilitate a leak proof seal between the body portion and the lid portion.

4. The container of claim 1, wherein the first element is a lock member and the second element is a receiver member, wherein the lock member is configured to engage with the receiver member when the lid portion is closed over the body portion.

5. The container of claim 4, wherein horizontal force and upward force applied to the lock member relative to the body portion causes the lock member to disengage from the receiver member.

6. The container of claim 1, wherein the hinge is a living hinge.

7. The container of claim 1, wherein the lid portion comprises a first complementary stackable feature and the body portion comprises a second complementary stackable feature.

8. The container of claim 1, further comprising a thumb tab push area configured to provide a closing force that aids in sealing the container.

9. The container of claim 1, wherein the body portion is formed during a first molding process and the lid portion and the gasket are formed during a second molding process.

10. The container of claim 1, wherein the gasket is formed during a first molding process and the body portion and the lid portion are formed during a second molding process.

11. The container of claim 10, wherein the body portion and the lid portion are formed of translucent material and the gasket is formed of colored material.

12. A method, comprising:
forming a body portion and a lid portion, wherein the body portion and the lid portion are operatively connected with a hinge;
forming a gasket with the body portion or the lid portion, wherein the gasket comprises built in compression; and
forming a first element on the lid portion and a second element on the body portion, wherein the first element and the second element comprise a positive lock.

13. The method of claim 12, wherein the forming the gasket comprises forming the gasket integral to the lid portion and wherein the built in compression facilitates compression of the gasket to flip the positive lock into a secure position when the lid portion is engaged with the body portion.

14. The method of claim 12, wherein the forming the gasket comprises forming the gasket integral to the body portion and wherein the lid portion comprises a seal that operates with the gasket to facilitate a leak proof seal between the body portion and the lid portion.

15. The method of claim 12, wherein the forming the first element and the second element comprises forming a lock member and a receiver member, wherein the lock member is configured to engage with the receiver member when the lid portion is closed over the body portion.

16. The method of claim 12, wherein the forming the body portion and the lid portion comprises forming a living hinge between the body portion and the lid portion.

17. The method of claim 12, wherein the forming the lid portion and the body portion comprises forming a first complementary stackable feature on the lid portion and forming a second complementary stackable feature on the body portion.

18. The method of claim 12, wherein the forming the body portion and the lid portion comprises forming the body portion and the lid portion with a translucent material and forming the gasket comprises forming the gasket of colored material.

19. A method, comprising:
forming a body and a lid of a container, the body and the lid are operatively connected with a living hinge and wherein the body comprises a first lock element and the lid comprises a second lock element;
forming a gasket with built in compression, wherein the gasket is formed on the lid;
closing the lid onto the body, wherein the first lock element engages the second lock element and compresses the gasket; and
preparing the container for storage or shipment.

20. The method of claim 19, further comprising:
ejecting the container from a mold after the closing the lid onto the body.
